(19) United States
(12) Patent Application Publication
(10) Pub. No.: US 2005/0022061 A1
(43) Pub. Date: Jan. 27, 2005

(54) Content transmission device and content transmission method, content reception device and content reception method

(75) Inventors: Tomoe Ozasa, Ome-shi (JP); Takashi Kokubo, Ome-shi (JP); Takehiko Okuyama, Yokohama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/825,432

(22) Filed: Apr. 16, 2004

(30) Foreign Application Priority Data
Jun. 30, 2003 (JP) 2003-187027

(51) Int. Cl. G06F 11/00

(52) U.S. Cl. 714/37

(57) ABSTRACT

A content transmission device which is capable of inputting contents including copy control information and outputting the contents, comprising a copy control information detection unit configured to detect the copy control information from the inputted contents, a copy control information judgment unit configured to judge whether or not it is possible to output the contents from the detected copy control information, a content output control unit configured to control the contents in an output failure state in a case where it is judged that the output of the contents is impossible, and an output failure information output unit configured to output failure information indicating that the contents are in the output failure state instead of the contents controlled in the output failure state by the content output control unit.

### CROSS-REFERENCE TO RELATED APPLICATIONS

This application is based upon and claims the benefit of priority from prior Japanese Patent Application No. 2003-187027, filed Jun. 30, 2003, the entire contents of which are incorporated herein by reference.

### BACKGROUND OF THE INVENTION

1. Field of the Invention

The present invention relates to a content transmission device and method in which transmission of contents is restricted based on copy control information. The present invention also relates to a content reception device and method in which the contents transmitted based on the content transmission device and method are received.

2. Description of the Related Art

As is well known, in recent years, it has been possible to construct a network system in which a plurality of AV apparatuses are interconnected in a free mode via a serial bus using a digital interface in conformity to IEEE (the Institute of Electrical and Electronics Engineers, Inc.) 1394 standards.

The IEEE 1394 serial bus is used especially in the digital interface between digital broadcasting reception apparatuses such as set top box (STB) and digital recording/reproducing apparatuses such as a digital-video home system (D-VHS) apparatus, and constructs a high-grade recording/reproducing system.

Moreover, digital transmission content protection (DTCP) standards are defined in the network system using the IEEE 1394 serial bus in order to protect copyrights of contents on the serial bus, and the respective apparatuses connected onto the serial bus are set in accordance with the standards.

A copy control function of controlling outputs of contents (including analog video signal, analog audio signal, digital data and the like) is mounted on the apparatus in conformity to the DTCP standards in order to prevent the contents whose copyrights are asserted from being unduly copied.

For example, with a digital broadcasting reception apparatus which receives satellite digital broadcasting, a copy control content is interpreted from bit information of copy control information (CCI) included in a program map table (PMT) of received MPEG (moving picture experts group) 2-TS (transport stream).

Moreover, when an object of copy control is an analog video signal output, a copy generation management system on analog video interface (CGMS-A) and an analog protection system (APS) are added to the analog video signal to perform the copy control.

Furthermore, when the object of copy control is an optical digital audio data output, a serial copy management system (SCMS) is added to the optical digital audio data output to perform the copy control. Additionally, when the object of copy control is an IEEE 1394 digital data output, an encryption mode indicator (EMI) and DCTP descriptor are added to the IEEE 1394 digital data to perform the copy control.

Additionally, there is a so-called “output failure” state in which control is executed so as to prevent the contents from being outputted in the copy control function. In actual, in case of the output failure of the analog video signal, a substitute signal is outputted to display a black or blue screen instead of the analog video signal.

In this case, there are some apparatuses in which message information indicating “display is impossible because of output failure” is added to the substitute signal to display the black or blue screen by an on screen display (OSD) function and is outputted. In an apparatus which receives this output, it can be recognized by the message information that the apparatus on the transmission is in the “output failure” state.

However, there are a few apparatuses including a message information send function described above, and most of the apparatuses simply output the substitute signal to display the black or blue screen. Therefore, the apparatus on the reception only receives the substitute signal to display the black or blue screen, and this causes a problem that it is difficult to recognize that the apparatus on the transmission is in the “output failure” state.

Moreover, also with the output failure of the IEEE 1394 digital data, an empty packet which does not include video data is simply outputted as the substitute signal by isochronous transmission which is one type of synchronous communication, and this still causes a problem that it is difficult for the apparatus on the reception to recognize that a user is in the “output failure” sate.

In Jpn. Pat. Appln. KOKAI Publication No. 2002-251328, a content storage management method is described in which meta data describing detailed information on the contents is defined so that various controls with respect to the contents can be performed with the meta data.

However, in the publication, as described above, there is not any description about solution of the problem that it is difficult for the apparatus on the reception to recognize that the apparatus on the transmission is brought into the output failure state by the copy control function.

### BRIEF SUMMARY OF THE INVENTION

According to one aspect of the present invention, there is provided a content transmission device which is capable of inputting contents including copy control information and outputting the contents, comprising: a copy control information detection unit configured to detect the copy control information from the inputted contents; a copy control information judgment unit configured to judge whether or not it is possible to output the contents from the detected copy control information; a content output control unit configured to control the contents in an output failure state in a case where it is judged that the output of the contents is impossible; and an output failure information output unit configured to output output failure information indicating that the contents are in the output failure state instead of the contents controlled in the output failure state by the content output control unit.

According to one aspect of the present invention, there is provided a content transmission method which is capable of inputting contents including copy control information and outputting the contents, comprising: detecting the copy control information from the inputted contents; judging whether or not it is possible to output the contents from the detected copy control information; controlling the contents in an output failure state in a case where it is judged that the output of the contents is impossible; and outputting output failure information indicating that the contents are in the output failure state instead of the contents controlled in the output failure state.

According to one aspect of the present invention, there is provided a content reception device in which contents are inputted and subjected to predetermined signal processing, comprising: an output failure information extraction unit configured to extract output failure information added based on copy control information from the inputted contents; an output failure information judgment unit configured to judge the extracted output failure information; and an output failure information notification unit configured to notify that the contents are in an output failure state based on a judgment result of the output failure information judgment unit.

According to one aspect of the present invention, there is provided a content reception method in which a plurality of types of contents different in system are inputted and each of the contents is subjected to predetermined signal processing, comprising: extracting output failure information added based on copy control information from the inputted plurality of types of contents; judging a content of the extracted output failure information; and notifying the contents brought in an output failure state based on a judgment result of the output failure information.

### BRIEF DESCRIPTION OF THE SEVERAL VIEWS OF THE DRAWING

FIG. 1 is a block diagram showing an outline of a network system according to one embodiment of the present invention;

FIG. 2 is a block diagram showing details of a digital broadcasting reception apparatus in the network system;

FIG. 3 is an explanatory view showing a data format of digital control information inserted in VBI of an analog video signal outputted from the digital broadcasting reception apparatus;

FIG. 4 is an explanatory view of a structure of MPEG2-TS packet outputted from the digital broadcasting reception apparatus;

FIG. 5 is an explanatory view of the structure of a CIP header included the MPEG2-TS packet;

FIG. 6 is a flowchart showing a main operation in the digital broadcasting reception apparatus;

FIG. 7 is a block diagram showing the details of a recording/reproducing apparatus in the network system;

FIG. 8 is a flowchart showing the main operation in the recording/reproducing apparatus;

FIG. 9 is a block diagram showing a modification of the recording/reproducing apparatus;

FIG. 10 is a block diagram showing another modification of the recording/reproducing apparatus;

FIG. 11 is an explanatory view of the structure of one packet of MPEG2-TS transmitted by RTP via Ethernet in the embodiment;

FIG. 12 is an explanatory view showing the details of an RTP header included in the packet;

FIG. 13 is an explanatory view of the details of an RTP extension header added to the RTP header; and

FIG. 14 is an explanatory view of an HTTP header transmitted by HTTP via Ethernet in the embodiment.

### DETAILED DESCRIPTION OF THE INVENTION

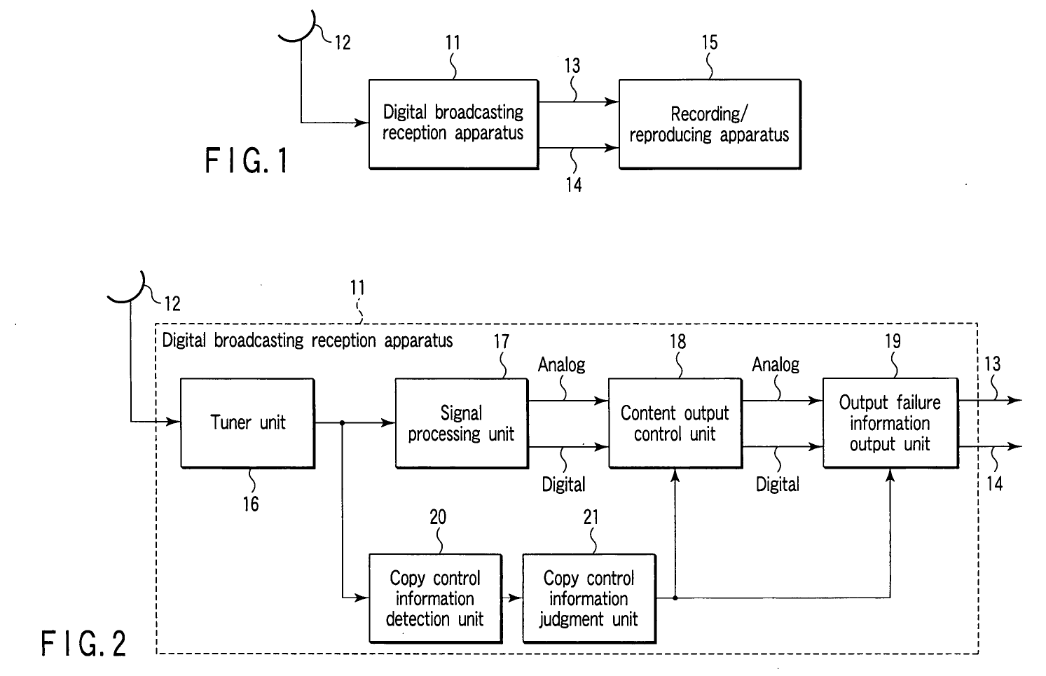

One embodiment of the present invention will hereinafter be described in detail with reference to the drawings. FIG. 1 shows an outline of a network system described in the embodiment. In FIG. 1, reference numeral 11 denotes a digital broadcasting reception apparatus.

The digital broadcasting reception apparatus 11 is capable of extracting contents of a desired channel from a satellite digital broadcasting signal received via an antenna 12, and outputting the contents in either or both of analog and digital systems.

Among the contents, analog contents contain video and audio information components, and are derived to the outside of the digital broadcasting reception apparatus 11 via an analog cable 13. Digital contents contain video, audio and character information components, and are derived to the outside of the digital broadcasting reception apparatus 11 via an IEEE 1394 serial bus 14.

Moreover, the contents outputted from the digital broadcasting reception apparatus 11 are supplied to a recording/reproducing apparatus 15 for the recording/reproducing. The recording/reproducing apparatus 15 has a function of analog-recording/reproducing the contents inputted through the analog cable 13, and a function of digital-recording/reproducing the contents inputted through the IEEE 1394 serial bus 14.

FIG. 2 shows details of the digital broadcasting reception apparatus 11. That is, the satellite digital broadcasting signal received via the antenna 12 is supplied to a tuner unit 16, and the contents of a desired channel are extracted. The contents extracted by the tuner unit 16 are supplied to a signal processing unit 17, subjected to error correction processing and demodulation processing, and thereafter outputted in each of the analog and digital systems.

The contents outputted from the signal processing unit 17 in the analog and digital systems are respectively derived to the outside of the digital broadcasting reception apparatus 11 via a content output control unit 18 and an output failure information output unit 19 and then via the analog cable 13 and IEEE 1394 serial bus 14.

Moreover, the contents extracted by the tuner unit 16 are supplied to a copy control information detection unit 20 and copy control information is detected. The copy control information detected by the copy control information detection unit 20 is supplied to a copy control information judgment unit 21 and the content of the information is judged. Furthermore, the operations of the content output control unit 18 and output failure information output unit 19 are controlled based on the judgment result of the copy control information judgment unit 21.

Now, when the copy control information detected by the copy control information detection unit 20 has a content that does not restrict the output with respect to the contents of the analog and digital systems, the content output control unit 18 and output failure information output unit 19 operate so as to pass the contents outputted from the signal processing unit 17 in the analog and digital systems as they are and to supply them to the analog cable 13 and IEEE 1394 serial bus 14.

Moreover, when the copy control information detected by the copy control information detection unit 20 has a content that imposes output restrictions on the analog video signal, the content output control unit 18 operates not to output the analog video signal outputted from the signal processing unit 17.

At this time, the output failure information output unit 19 operates so as to output a substitute analog video signal by which a black or blue screen is displayed to the analog cable 13 instead of the analog video signal outputted from the signal processing unit 17.

Moreover, at this time, the output failure information output unit 19 sets an analog video output failure bit set to an empty bit of digital control information inserted in an vertical blanking interval (VBI) of the substitute analog video signal outputted to the analog cable 13 to “1” indicating that the output of the analog video signal is not permitted.

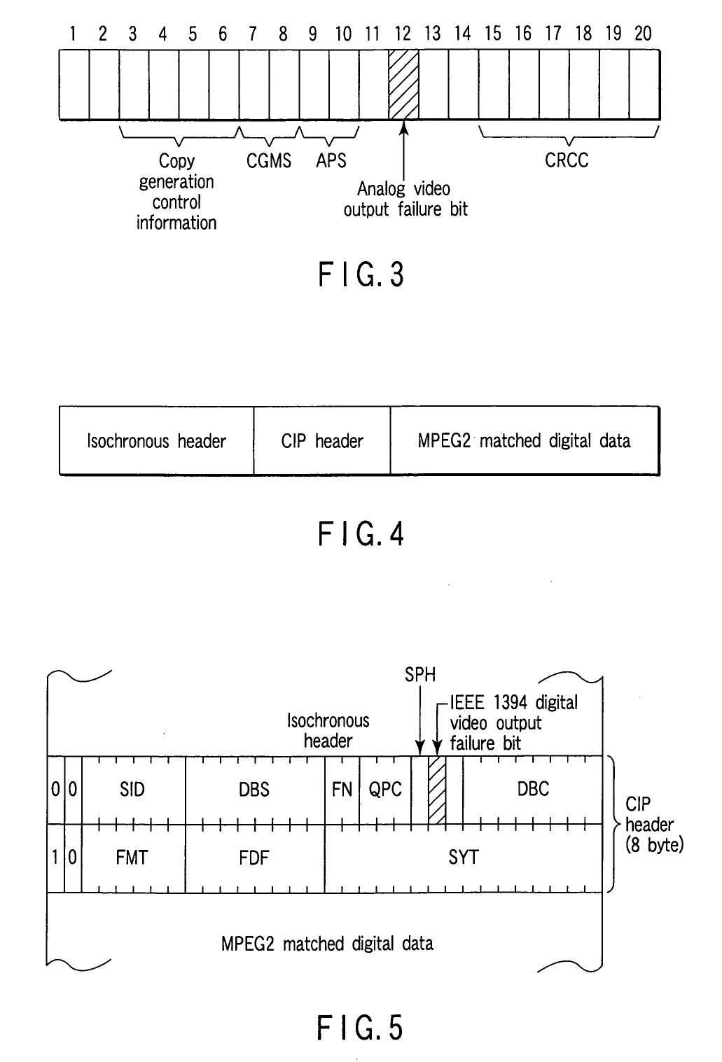

FIG. 3 shows a data format of digital control information inserted in VBI of the analog video signal. The digital control information is constituted of 20 bits, third to sixth bits constitute copy generation control information, seventh and eighth bits constitute CGMS information, ninth and tenth bits constitute APS information, and fifteenth to twentieth bits constitute a cyclic redundancy check code (CRCC).

A twelfth bit which is one of empty bits in the digital control information are set to bits indicating the output failure of the analog video signal. Moreover, when the copy control information has the content imposing the output restrictions on the analog video signal, the output failure information output unit 19 sets the analog video output failure bit to “1” indicating that the output of the analog video signal is not permitted.

It is to be noted that when the copy control information has a content that does not impose the output restrictions on the analog video signal, the output failure information output unit 19 sets the analog video output failure bit to “0”.

Therefore, in the recording/reproducing apparatus 15, the content of the analog video output failure bit of the digital control information inserted in the VBI of the analog video signal supplied via the analog cable 13 is detected, and accordingly it can easily be judged whether or not the digital broadcasting reception apparatus 11 is in the output failure state of the analog video signal.

Moreover, when the copy control information detected by the copy control information detection unit 20 has the content imposing the output restrictions on the IEEE 1394 digital video data, the content output control unit 18 operates not to output the IEEE 1394 digital video data outputted from the signal processing unit 17.

At this time, the output failure information output unit 19 operates so as to output an empty packet which does not include video data as substitute data to the IEEE 1394 serial bus 14 by the isochronous transmission instead of the IEEE 1394 digital video data outputted from the signal processing unit 17.

Moreover, at this time, the output failure information output unit 19 sets the IEEE 1394 digital video output failure bit set to the empty bit of a common isochronous packet (CIP) header included in the empty packet outputted to the IEEE 1394 serial bus 14 to “1” indicating that the output of the IEEE 1394 digital video data is not permitted.

FIG. 4 shows a structure of one packet of MPEG2-TS isochronously transmitted on the IEEE 1394 serial bus 14. That is, one packet includes an isochronous header, CIP header and MPEG2 matched digital data. Among the packets, packets which do not include the video data are empty packets.

FIG. 5 shows details of the CIP header. The CIP header is constituted of eight bytes (two quadlets) while one byte is constituted of eight bits. The first four bytes (first quadlet) includes: a source node ID (SID) indicating a node identification (ID) of the digital broadcasting reception apparatus 11; a data block size in quadlets (DBS) indicating a size of a divided data block; a fraction number (FN) indicating the number of divided data blocks; a quadlet padding count (QPC) indicating the number of quadlets added for the dividing; a source packet header present (SPH) indicating presence/absence of a source packet header; and DBC indicating a data block continuity counter.

Moreover, the latter four bytes (second quadlet) include a format ID (FMT) indicating the format of the packet data, FDF indicating a format dependent field, and a sync time (SYT) for inserting time information to establish synchronization.

The empty bit adjacent to SPH of the first quadlet in the CIP header is set to the bit indicating the output failure of the IEEE 1394 digital video data. Moreover, when the copy control information has the content imposing the output restrictions on the IEEE 1394 digital video data, the output failure information output unit 19 sets the IEEE 1394 digital video output failure bit to “1” indicating that the output of the IEEE 1394 digital video data is not permitted.

It is to be noted that when the copy control information has the content that does not impose the output restrictions on the IEEE 1394 digital video data, the output failure information output unit 19 sets the IEEE 1394 digital video output failure bit to “0”.

Therefore, in the recording/reproducing apparatus 15, the content of the IEEE 1394 digital video output failure bit inserted in the CIP header of the MPEG2-TS packet supplied via the IEEE 1394 serial bus 14 is detected, and accordingly it can easily be judged whether or not the digital broadcasting reception apparatus 11 is in the output failure state of the IEEE 1394 digital video data.

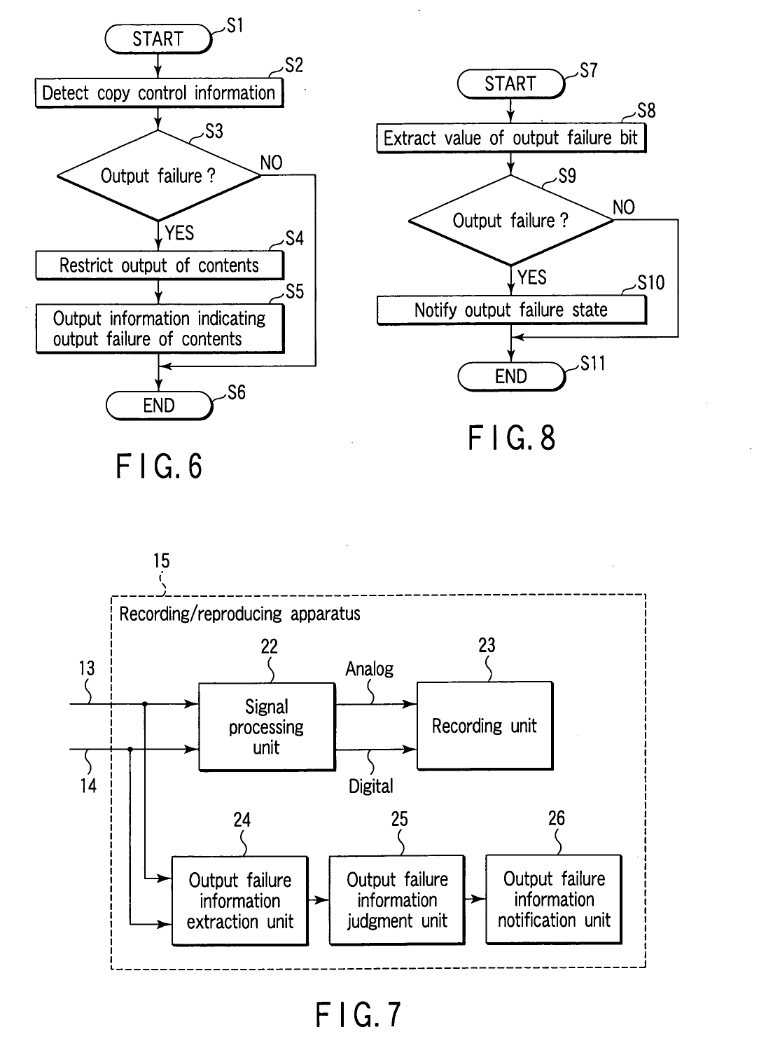

FIG. 6 shows a flowchart showing an operation of the digital broadcasting reception apparatus 11 to add information indicating whether or not the contents are in the output failure state based on the copy control information.

First, the digital broadcasting reception apparatus 11 starts reception of the contents of a desired channel (step S1). Then, in step S2, copy control information such as embedded CCI and EMI is detected from the received contents. In step S3, it is judged whether or not the presently received contents are in the output failure state for each output.

When it is judged that the contents do not correspond to the output failure (NO), the process ends as it is (step S6), and thereafter the received contents are freely outputted.

Moreover, when there exist contents judged to correspond to the output failure in the step S3 (YES), in step S4 the contents are inhibited from being outputted, in step S5 information (output failure information) indicating that the contents are in the output failure state is added to the substitute signal outputted instead of the contents and outputted, and the processing ends (step S6).

FIG. 7 shows the details of the recording/reproducing apparatus 15. That is, the contents of the analog and digital systems supplied via the analog cable 13 and IEEE 1394 serial bus 14 are respectively supplied to a signal processing unit 22 and subjected to predetermined signal processing and thereafter recorded by a recording unit 23. It is to be noted that the recording/reproducing apparatus 15 has a function of reproducing the contents recorded in the recording unit 23 and outputting the contents in the analog and digital systems.

Here, the contents of the analog and digital systems supplied via the analog cable 13 and IEEE 1394 serial bus 14 are respectively supplied to an output failure information extraction unit 24, and the output failure information is extracted for each input.

That is, the output failure information extraction unit 24 extracts the value of an analog video output failure bit of digital control information shown in FIG. 3 with respect to the analog video signal supplied via the analog cable 13.

Moreover, the value of the IEEE 1394 digital video output failure bit of the CIP header shown in FIG. 5 is extracted with respect to the IEEE 1394 digital video data supplied via the IEEE 1394 serial bus 14.

The value of each output failure bit extracted by the output failure information extraction unit 24 is supplied to an output failure information judgment unit 25, and it is judged whether the content of the bit is “1” indicating the output failure state or “0” indicating an output possible state for each output failure bit.

The judgment result judged by the output failure information judgment unit 25 for each output failure bit is supplied to an output failure information notification unit 26. The output failure information notification unit 26 functions so as to notify the contents brought in “output failure” state based on the judgment result for each output failure bit.

That is, when the value of the analog video output failure bit is “1”, the output failure information notification unit 26 notifies that the digital broadcasting reception apparatus 11 is not capable of outputting the analog video signal.

Moreover, when the value of the IEEE 1394 digital video output failure bit is “1”, the notification unit notifies that the digital broadcasting reception apparatus 11 is not capable of outputting the IEEE 1394 digital video data.

Therefore, the recording/reproducing apparatus 15 is capable of easily detecting the contents in the output failure state of the digital broadcasting reception apparatus 11 by the copy control function.

It is to be noted that as a notification mode by the output failure information notification unit 26, for example, it is supposed that the contents in the output failure state are video-displayed in a display unit disposed to display the contents recorded in the recording unit 23.

FIG. 8 is a flowchart showing the operation of the recording/reproducing apparatus 15 to notify that the digital broadcasting reception apparatus 11 is in the output failure state of the contents based on the output failure information.

First, when the recording/reproducing apparatus 15 inputs the contents sent from the digital broadcasting reception apparatus 11 in various systems, the processing is started (step S7). Then, in step S8 the value of the output failure bit included in each inputted content is extracted, and it is judged in step S9 whether or not the value of each output failure bit corresponds to the output failure state.

When there exist contents judged to have the value of the output failure bit that does not correspond to the output failure state (NO), the process ends as it is (step S11). Thereafter, the inputted contents are freely recorded.

Moreover, there exist contents judged to have the value of the output failure bit that corresponds to the output failure state in the step S9 (YES), in the step S10 it is notified that the contents have the output failure state, and the process ends (step S11).

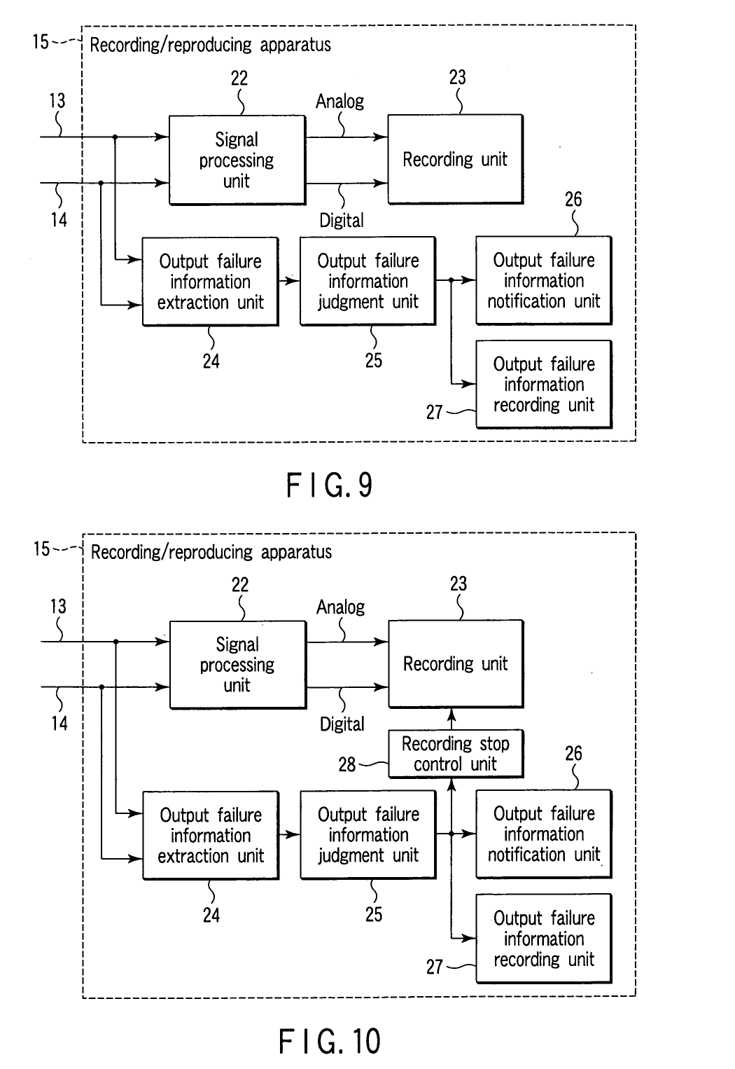

FIG. 9 shows a modification of the recording/reproducing apparatus 15. In FIG. 9, the same components as those of FIG. 7 are denoted with the same reference numerals, and the modification will be described. The judgment result of the output failure information judgment unit 25 is recorded by an output failure information recording unit 27.

In accordance with the constitution, when the contents outputted from the digital broadcasting reception apparatus 11 are recorded in the recording unit 23, the contents recorded in the recording unit 23 are collated with the judgment results recorded in the output failure information recording unit 27, and accordingly the recorded contents in the output failure state can easily be identified.

Therefore, for example, when the content recorded in the recording unit 23 are reproduced, only the black screen is displayed. In this case, when the judgment result recorded in the output failure information recording unit 27 is referred to, the contents in the output failure state can easily be identified, and can be distinguished from recording failure by a trouble.

FIG. 10 shows another modification of the recording/reproducing apparatus 15. In FIG. 10, the same components as those of FIG. 9 are denoted with the same reference numerals, and the modification will be described. The judgment result of the output failure information judgment unit 25 is supplied to a recording stop control unit 28. The recording stop control unit 28 stops the recording operation of the recording unit 23 with respect to the contents judged to have the output failure state.

In accordance with this constitution, since the contents judged to have the output failure state are not recorded, a recording capacity in the recording unit 23 can be saved. Moreover, when reservation recording or the like is performed, the contents are collated with the recorded contents of the output failure information recording unit 27. Accordingly, it can easily be recognized that the recording is not performed because the apparatus on the transmission is brought into the output failure state.

Here, in the above-described embodiment, it has been described that the output failure information is added to the VBI of the analog video signal the CIP header included in the empty packet of the isochronous transmission. However, the present invention is not limited to the transmission system. For example, also when the digital video data is transmitted with a real-time transport protocol (RTP) or hypertext transfer protocol (HTTP) via Ethernet, the output failure information can be added.

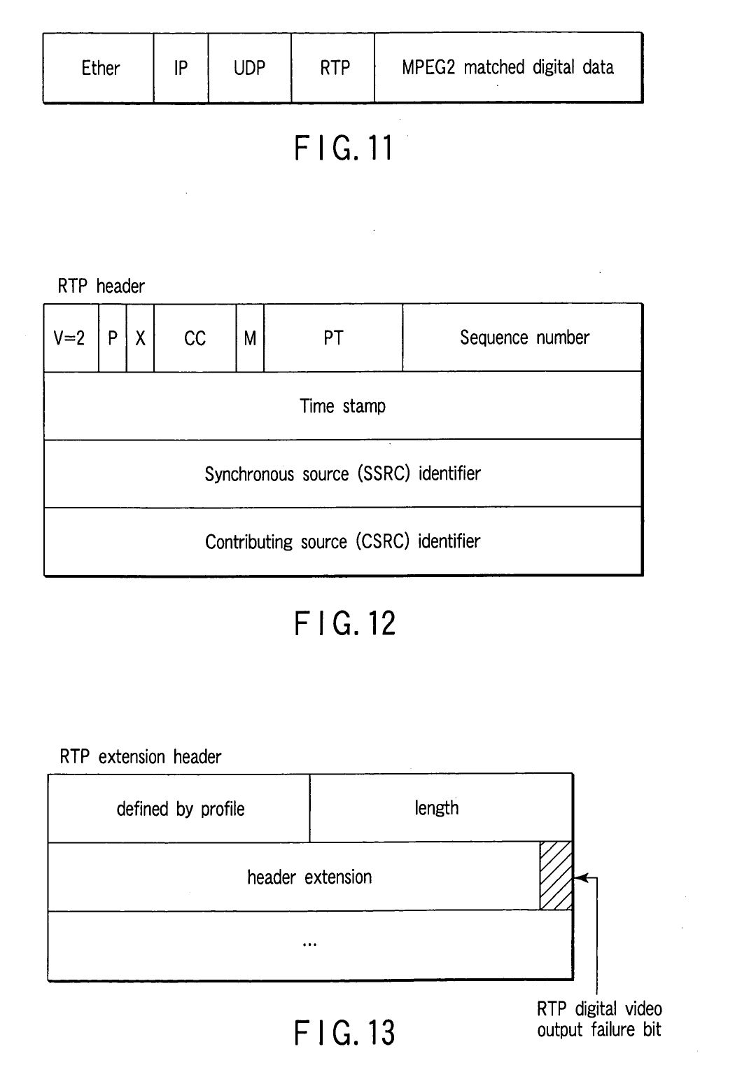

FIG. 11 shows the structure of one packet of MPEG2-TS transmitted by RTP via Ethernet. One packet includes Ether (Ethernet) header, 20 to 60 bytes of internet protocol (IP) header, eight bytes of user datagram protocol (UDP) header, and 12 bytes of RTP header and MPEG2 matched digital data.

FIG. 12 shows the details of an RTP header. The RTP header includes a version number V (version), bit P (padding) for adjustment, extension bit X (extension), the number CC (CSRC count) of contributing source (CSRC) identifiers, marker (M), payload type (PT), sequence number, time stamp, synchronous source (SSRC) identifier and contributing source (CSRC) identifier of RTP.

FIG. 13 shows the details of an RTP extension header added behind the RTP header, when the extension bit X is “1”. The RTP extension header is defined by profile, length and header extension. The empty bit in the header extension is set to a bit indicating the output failure of the RTP digital video data.

Moreover, when the output restrictions are imposed on the RTP digital video data, the RTP digital video output failure bit is set to “−1” indicating that the output of the RTP digital video data is not permitted. It is to be noted that when the output restrictions are not imposed on the RTP digital video data, the RTP digital video output failure bit is set to “0”.

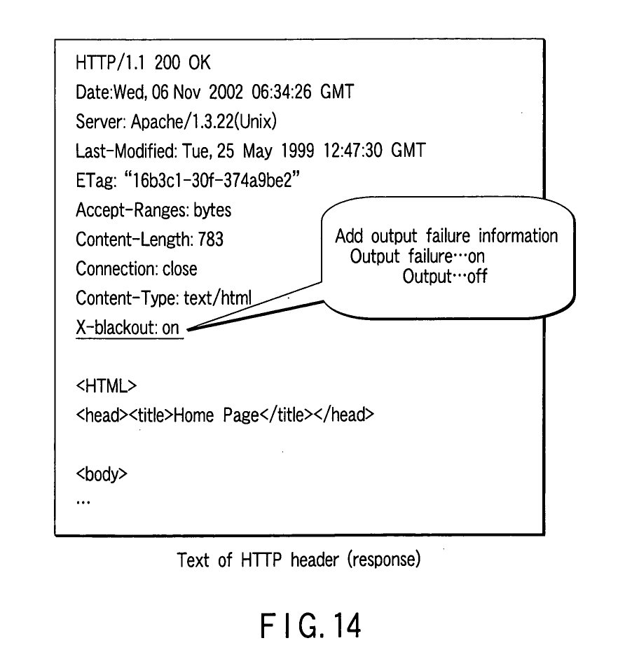

Furthermore, when the digital video data is transmitted to HTTP via Ethernet, as shown in FIG. 14, the output failure information is added to the last of the HTTP header of a response to HTTP request. In this case, “on” indicates output failure, and “off” indicates that the output is possible.

It is to be noted that the present invention is not limited to the above-described embodiment as it is and that constituting elements can variously be modified or embodied without departing from the scope in an implementation stage. Various invention can be formed by an appropriate combination of a plurality of constituting elements described in the above-described embodiment. For example, some constituting elements may also be removed from all the constituting elements described in the embodiment. Furthermore, the constituting elements of different embodiments may also appropriately be combined.

1. A content transmission device which is capable of inputting contents including copy control information and outputting the contents, comprising:
a copy control information detection unit configured to detect the copy control information from the inputted contents;
a copy control information judgment unit configured to judge whether or not it is possible to output the contents from the detected copy control information;
a content output control unit configured to control the contents in an output failure state in a case where it is judged that the output of the contents is impossible; and
an output failure information output unit configured to output output failure information indicating that the contents are in the output failure state instead of the contents controlled in the output failure state by the content output control unit.

2. A content transmission device according to claim 1, wherein the output failure information output unit is configured to add the output failure information to VBI of an analog video signal and to output the output failure information.

3. A content transmission device according to claim 1, wherein the output failure information output unit is configured to add the output failure information to a CIP header included in an isochronous packet of IEEE 1394 digital video data and to output the output failure information.

4. A content transmission device according to claim 1, wherein the output failure information output unit is configured to add the output failure information to an RTP extension header of digital video data outputted by RTP via Ethernet and to output the output failure information.

5. A content transmission device according to claim 1, wherein the output failure information output unit is configured to add the output failure information to an HTTP header of digital video data outputted by HTTP via Ethernet and to output the output failure information.

6. A content transmission method which is capable of inputting contents including copy control information and outputting the contents, comprising:
detecting the copy control information from the inputted contents;
judging whether or not it is possible to output the contents from the detected copy control information;
controlling the contents in an output failure state in a case where it is judged that the output of the contents is impossible; and
outputting output failure information indicating that the contents are in the output failure state instead of the contents controlled in the output failure state.

7. A content reception device in which contents are inputted and subjected to predetermined signal processing, comprising:
an output failure information extraction unit configured to extract output failure information added based on copy control information from the inputted contents;
an output failure information judgment unit configured to judge the extracted output failure information; and
an output failure information notification unit configured to notify that the contents are in an output failure state based on a judgment result of the output failure information judgment unit.

8. A content reception device according to claim 7, wherein the output failure information extraction unit is configured to extract the output failure information added based on the copy control information from a plurality of types of contents which differ with type,
the output failure information judgment unit is configured to judge a content of the output failure information extracted from the plurality of types of contents, and
the output failure information notification unit is configured to notify the contents in the output failure state based on judgment results of the output failure information judgment unit.

9. A content reception device according to claim 7 or 8, further comprising:
a content recording unit configured to record the inputted contents; and
an output failure information recording unit configured to record the judgment result of the output failure information judgment unit in accordance with the contents recorded in the content recording unit.

10. A content reception device according to claim 9, further comprising:
a content recording stop unit configured to stop the recording by the content recording unit with respect to the contents judged to have the output failure state by the output failure information judgment unit.

11. A content reception method in which a plurality of types of contents different in system are inputted and each of the contents is subjected to predetermined signal processing, comprising:
extracting output failure information added based on copy control information from the inputted plurality of types of contents;
judging a content of the extracted output failure information; and
notifying the contents brought in an output failure state based on a judgment result of the output failure information.

12. A content reception method according to claim 11, further comprising:
recording the inputted contents; and
recording the judgment result of the output failure information in accordance with the recorded contents.

13. A content reception device according to claim 12, further comprising:
stopping the recording of the contents judged to is have the output failure state.
